(19) United States
(12) Patent Application Publication
(10) Pub. No.: US 2006/0003219 A1
(43) Pub. Date: Jan. 5, 2006

(54) Fuel cell having mechanism for pressurizing membrane electrode assembly and electronic device equipped with the same

(76) Inventors: Ryuji Kohno, Kasumigaura (JP); Tatsuya Nagata, Ishioka (JP); Makoto Kitano, Tsuchiura (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/169,775

(22) Filed: Jun. 30, 2005

(30) Foreign Application Priority Data
Jul. 1, 2004 (JP) 2004-195978

(51) Int. Cl. H01M 2/08; H01M 8/10; H01M 8/02

(52) U.S. Cl. 429/37; 429/30; 429/34

(57) ABSTRACT

It is an object of the present invention to provide a fuel cell having a pressurizing mechanism which can optimize pressure applied to a membrane electrode assembly (MEA) working as a power-generating element to realize high-efficiency power generation and an electronic device equipped with the same.

The fuel cell 10A comprises the membrane electrode assembly module 20 which consumes the liquid fuel 40 to generate power, and the fuel chamber 30 for supplying the liquid fuel 40 which it holds inside to the membrane electrode assembly module 20 from the aperture 31, wherein it is provided with the pressurizing member 60 on the membrane electrode assembly module 20, clamping member 53 for fixing the pressurizing member 60 and fuel chamber 30, and elastic member for applying a pressure on the membrane electrode assembly module 20 in its thickness direction, to solve the problems.

### BACKGROUND OF THE INVENTION

The present invention relates to a fuel cell, more particularly a pressurizing mechanism which can adjust pressure applied to a membrane electrode assembly (MEA) as a power-generating element.

Recently, direct methanol fuel cells (DMFCs), which directly use methanol as a liquid fuel to generate power, have been attracting attention as power sources for portable electronic devices, because they are compact, can produce high outputs and are serviceable continuously for extended periods.

FIG. 13 is a sectional view of conventional fuel cell, where (a) is a vertical sectional view of the whole fuel cell, and (b) is a partly enlarged sectional view of the membrane electrode assembly.

The conventional fuel cell 6 comprises the membrane electrode assembly 4 (composed of each layer of the cathode 1, electrolytic membrane 2 and anode 3) with the collecting plates 11 on both sides, where the assembly 6 is placed on the fuel chamber 5 filled with a liquid fuel (aqueous methanol solution). The fuel chamber 5 is provided with a plurality of through-holes 13 in one side in contact with the membrane electrode assembly through which the aqueous methanol solution flows to come into contact with the anode 3. This generates a potential difference across the anode 3 and cathode 1 by the electrode reaction, to output power to an external load via the collecting plate 11 (refer to, e.g., Patent Document 1).

The membrane electrode assembly 4 and fuel chamber 5 are held between the pressurizing member 7 and counter member 8 via the clamping member 9. In other words, the pressurizing member 7 and counter member 8 apply a pressure to the membrane electrode assembly 4 in the thickness direction to fix it on one side of the fuel chamber 5 under pressure.

Patent Document 1

JP-A-2004-79506 (Paragraphs 0022 to 0049, and FIG. 1)

### BRIEF SUMMARY OF THE INVENTION

The conventional fuel cell 6 involves the following problems. There is a relationship between pressure applied to one side of the membrane electrode assembly 4 and power output. Increasing the pressure improves contact in the interface between the layers constituting the membrane electrode assembly 4 to decrease the contact resistance there and improve power generating efficiency. On the other hand, increasing the pressure collapse more voids in the catalytic layer (cathode 1 and anode 3) for the membrane electrode assembly 4 to prevent smooth movement of the electrode reaction products (carbon dioxide and water) and the like. This retards the electrode reaction to decrease power generating efficiency.

It is, therefore, preferable to apply an adequate pressure to the membrane electrode assembly 4 in order to realize high-efficiency power generation by balancing the above conflicting effects.

However, it is structurally very difficult for the conventional fuel cell 6 to control pressure to the membrane electrode assembly at a given level.

It is also essential to uniformly apply an adequate pressure to each portion of the membrane electrode assembly 4 in order to realize high-efficiency power generation. However, the structure shown in FIG. 13 may not always apply a uniform pressure, when the portion in contact with the membrane electrode assembly 4 (e.g., pressurizing member 7 or one side of the fuel chamber 3) bends.

The present invention is developed to solve these problems. It is an object of the present invention to provide a fuel cell having a pressurizing mechanism which can apply an adequate pressure to a membrane electrode assembly working as a power-generating element, and apply a pressure to the assembly uniformly over the entire surface. It is another object to provide an electric device driven by the fuel cells.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1 shows a basic structure of a fuel cell of the first embodiment of the present invention, (a): vertical sectional view, and (b) plan view.

FIG. 2 shows an oblique view of a disassembled membrane electrode assembly module as a constitutional element of the present invention, and also an oblique view of the assembled membrane electrode assembly.

FIG. 3 shows an oblique view of a plate spring (elastic member) as a constitutional element of the present invention.

FIG. 4 shows (a) a plan view of a membrane electrode assembly module as a constitutional element of the present invention, and (b) a plan and vertical sectional views of a pressurizing member also as a constitutional element of the present invention.

FIG. 5 shows a plan and vertical sectional views of a pressurizing member as a constitutional element of the present invention.

FIG. 6 shows an oblique view of a disassembled fuel cell of the second embodiment of the present invention.

FIG. 7 shows plan views of (a) a membrane electrode assembly module of the fuel cell of the second embodiment of the present invention, and (b) that of a conventional fuel cell.

FIG. 8 shows an oblique view illustrating an assembled electronic device of the present invention.

FIG. 9(a) to (e) show vertical sectional views illustrating several types of fuel cell of the third embodiment of the present invention.

FIG. 10 shows a fuel cell of the second embodiment of the present invention, (a) plan view, (b) vertical sectional view of the cell cut along the line X-X.

FIG. 11 shows a fuel cell of the second embodiment of the present invention, (a) plan view, (b) vertical sectional view of the cell cut along the line X-X.

FIG. 12 shows a fuel cell of the second embodiment of the present invention, (a) plan view, (b) vertical sectional view of the cell cut along the line X-X.

FIG. 13 shows a conventional fuel cell, (a) vertical sectional view of the assembled cell, and (b) partly enlarged view.

### DESCRIPTION OF REFERENCE NUMERALS

10A, 10B, 10C, 10D, 10E, 10F and 10G: Fuel cell
20, 20B: Membrane electrode assembly module
21: Membrane electrode assembly
22: Electrolyte membrane
23, 23a: Anode
23, 23c: Cathode
24a: Collecting plate for anode
24c: Collecting plate for cathode
26a: Fuel hole
26c: Oxygen hole
28: Notch
30, 30B, 30C and 30E: Fuel chamber
31: Aperture
32: Basal lid
33: Fuel injection port
34: Cell body
35: Cell partition
36: Communicating hole
37: Cell space
40: Liquid fuel
41: Supporting column
52: Counter member
53: Clamping member
53a: Bolt
53b: Nut
54a, 54c: Coil spring (elastic member)
54b, 54h: Plate spring (elastic member)
54e: Cushion member (elastic member)
54f: Plate spring (elastic member)
54g: Beam member (elastic member)
57a, 57b, 57c: Gap-regulating member
60, 60A, 60B, 60C: Pressurizing member
61 (61a, 61b): Supply and discharge hole
62A, 62B, 62C: Pressurizing plate
63: Aperture
64: Groove
P: Portable terminal (electronic device)

### DETAILED DESCRIPTION OF THE INVENTION

The present invention is developed to solve the problems involved in conventional fuel cells, where an elastic member placed in a fuel chamber is an essential means for the fuel cell of the present invention, described in each claim. It can control pressure applied to a membrane electrode assembly for the fuel cell at an optimum level for high-efficiency power generation, when its spring constant or displacement amount is replaced for adequate ones, as required. Moreover, pressure can be applied to the membrane electrode assembly uniformly over the entire surface when a plurality of elastic members are used.

The embodiments of the present invention are described by referring to the attached drawings.

### First Embodiment

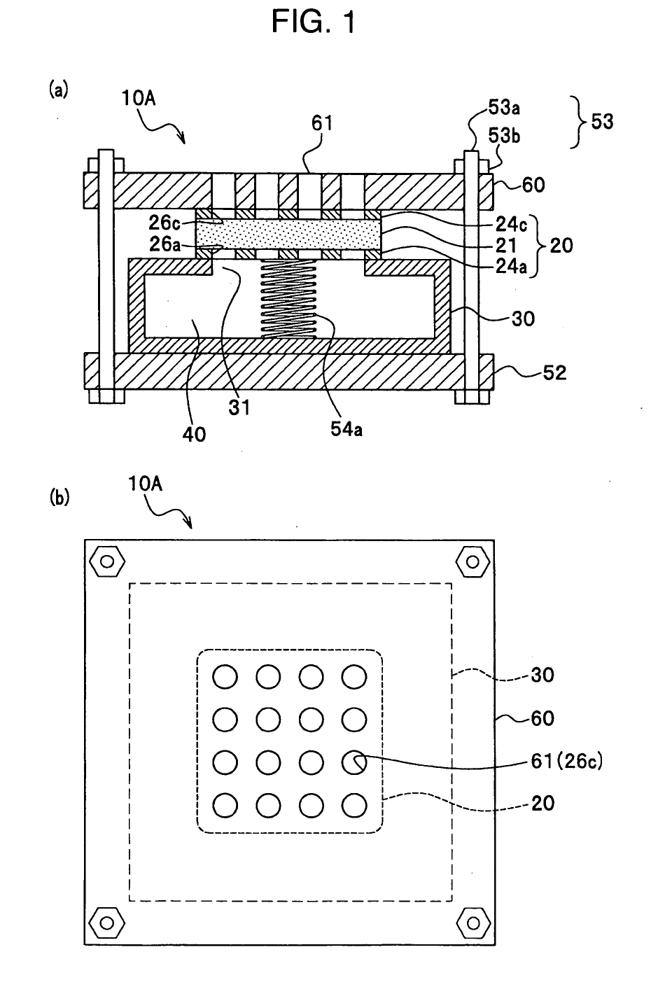

The first embodiment of the present invention is described by referring to FIG. 1, wherein (a) is vertical sectional view and (b) is a plan view of the fuel cell.

As illustrated in FIG. 1, the fuel cell 10A is composed of the essential components of membrane electrode assembly module 20 which consumes the liquid fuel 40 to generate power, fuel chamber 30 from which the liquid fuel 40 is supplied to the membrane electrode assembly module 20, and member (composed of the counter member 52, clamping member 53, pressurizing member 60 and coil spring an elastic member 54a).

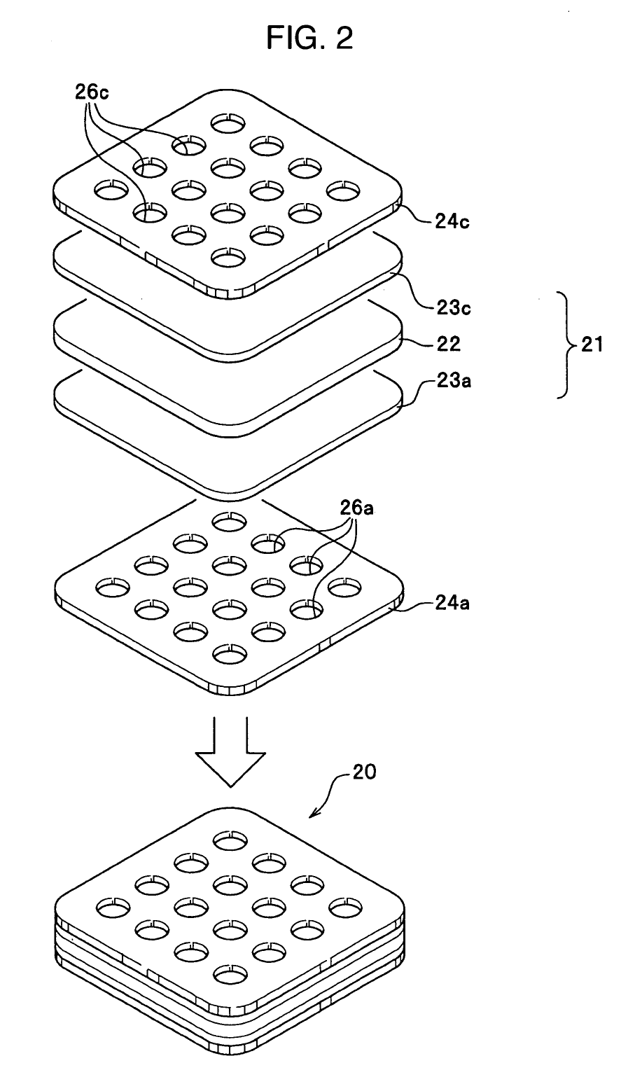

As illustrated in FIG. 2, the membrane electrode assembly module 20 is composed of the membrane electrode assembly (MEA) 21 held between 2 collecting plates (collecting plate for anode 24a and collecting plate for cathode 24c).

The membrane electrode assembly module 21 is composed of the electrolytic membrane 22 held between the anode 23a and cathode 23c.

The collecting plate for anode 24a, which is placed on the anode 23a on the side opposite to the electrolytic membrane 22, is provided with a plurality of fuel holes 26a on the surface from which the anode 23a is exposed to the outside.

On the other hand, the collecting plate 24c for cathode, which is placed on the cathode 23c on the side opposite to the electrolytic membrane 22, is provided with a plurality of oxygen holes 26c on the surface from which the cathode 23c is exposed to the outside. It is preferable that these fuel holes 26a and oxygen holes 26c stand face to face with the electrolytic membrane 22 in-between, as illustrated in FIG. 2.

When the fuel cell 10A is of a type of direct methanol fuel cell (DMFC), each constitutional element for the membrane electrode assembly module 20 responsible for power generation exhibits the following function(s).

First, the anode 23a oxidizes methanol (liquid fuel 40) which comes into contact with the anode 23a to generate the hydrogen ions and electrons. It is composed of a mixture of catalyst of fine ruthenium/platinum alloy particles which are supported by fine carbon particles. The electrons generated move towards the collecting plate 24a for anode, from which they are transmitted to the outside via an interconnection (not shown).

The electrolytic membrane 22 transmits the hydrogen ions generated at the anode 23a towards the cathode 23c as the counter electrode, while blocking the electrons. It is composed, e.g., of a polyperfluorosulfonic acid resin, more specifically Nafion (Trademark) or Aciplex (Trademark).

The cathode 23c works to reduce oxygen with the hydrogen ions moving through the electrolyte membrane 22. It is composed of a mixture of catalyst of fine platinum particles which are supported by fine carbon particles. The electrons required for the reduction are supplied from the collecting plate for cathode 24c via an interconnection (not shown).

The reactions occurring on the electrodes for the membrane electrode assembly 21, producing carbon dioxide as a by-product gas on the anode 23a and water as a by-product on the cathode 23c, are summarized below:

On the anode 23a
CH₃OH+H₂O→CO₂+6H⁺+6e⁻ (1)
On the cathode 23c
O₂+4H⁺+4e⁻→2H₂O (2)
Total reaction
CH₃OH+3/2O₂→CO₂+2H₂O (3)

The coil spring 54a is an elastic member, with the basal end coming into contact with the inner basal surface of the fuel chamber 30 and the front end pressing the membrane electrode assembly 20 in the thickness direction via the collecting plate for anode 24a (refer to FIG. 1). The pressure acting on the membrane electrode assembly 20 collapses irregularities in the interface between the anode 23a and collecting plate for anode 24a and that between the cathode 23c and collecting plate for cathode 24c to increase contact area and decrease electrical contact resistance. The pressure, when exceeding an adequate level, collapses voids formed by the carbon particles which support the catalyst in the anode 23a or cathode 23c, to prevent smooth movement of the by-product gas (carbon dioxide) on the anode 23a or by-product (water) on the cathode 23c, each being discharged through the voids, leading to deteriorated power generating efficiency.

Therefore, the coil spring (elastic member) 54 is set at an adequate spring constant and displacement in such a way to apply an optimum pressure at which the membrane electrode assembly module 20 generates power at the highest efficiency. FIG. 1(a) shows only one coil spring 54a. However, a plurality of the coil springs 54a may be used to apply a pressure to the membrane electrode assembly module 20 uniformly over the entire surface.

In the structure shown in FIG. 1, the membrane electrode assembly module 20 is clamped by the clamping member 54 at the four corners, with the result that it is subjected to a higher pressure at the four corners than in the center. Therefore, the coil spring 54a placed in the center presses the center of the membrane electrode assembly module 20 to secure a uniform pressure over the entire surface.

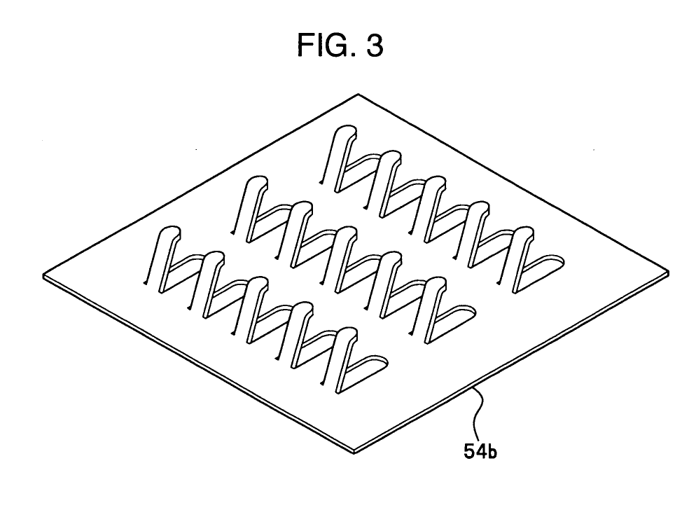

The plate spring 54b as an elastic member may be placed in the fuel chamber 30, instead of the coil spring 54a, as illustrated in FIG. 3. In this case, the angular spring is adjusted to have a spring force in such a way that it can press the membrane electrode assembly module 20 more strongly in the portion insufficiently clamped by the clamping member 53.

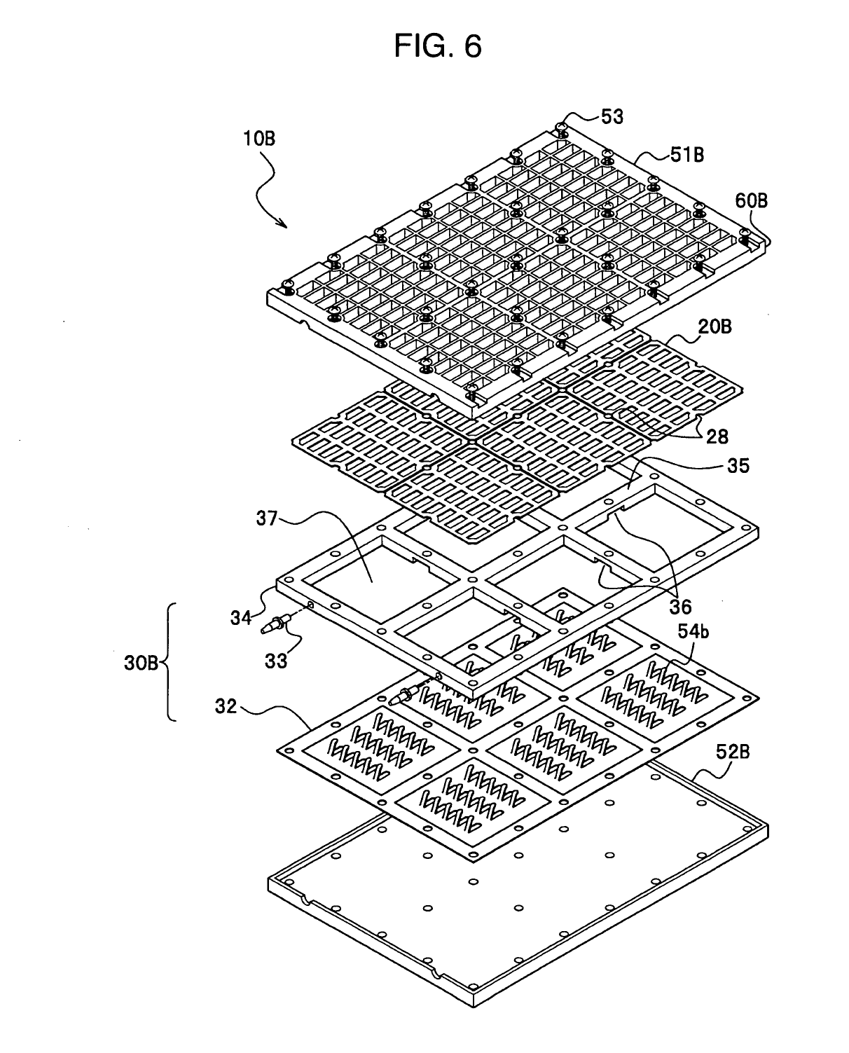

The fuel chamber 30 is filled with the liquid fuel 40 in its internal space, to work to supply the fuel 40 to the membrane electrode assembly module 20. The fuel chamber 30 is provided with one or more fuel injection ports (33 shown in FIG. 6), although not shown in FIG. 1, to supply the liquid fuel 40 from the outside into the inside. The liquid fuel 40 may be supplied by another method to make up the fuel consumed for power generation, e.g., continuous supply from a back-up tank (not shown) under a given pressure, or forced recycling.

The fuel chamber 30 is also provided with one or more discharge holes (not shown) at optional position(s), through which the by-product gas (carbon dioxide) generated on the anode 23a and accumulating inside, is discharged. The discharge hole is provided with a porous membrane (not shown) which can allow carbon dioxide to pass while blocking the liquid fuel 40 to selectively discharge carbon dioxide while allowing the fuel chamber 30 to securely seal the liquid fuel 40.

One side on the fuel chamber 30 is also provided with the aperture 31 having an area corresponding to the total area of the fuel holes 26a, and the membrane electrode assembly module 20 is designed to have these fuel holes 26a exposed through the aperture 31.

When the fuel chamber 30 is made of an electroconductive material, e.g., metal, it is necessary to provide an insulation membrane (not shown) in the interface between the fuel chamber 30 and collecting plate for anode 24a. This is to prevent the electrons generated on the anode 23a from running out through the fuel chamber 30.

The pressurizing member 60, located on the side of the collecting plate for cathode 24c in the membrane electrode assembly module 20, is provided with a plurality of the supply and discharge holes 61 which are in communication with a plurality of the oxygen holes 26c to take oxygen from air into the membrane electrode assembly module 20. The pressurizing member 60 and counter member 52 hold the membrane electrode assembly module 20 and fuel chamber 30 in-between by a clamping force provided by a plurality of bolts 53a and nuts (2 sets in the figure) running through these members where the module 20 is pressed to and fixed on the fuel chamber 30 at the aperture 31.

When the pressurizing member 60 is made of an electroconductive material, e.g., metal, it is necessary to provide an insulation membrane (not shown) in the interface between the pressurizing member 60 and collecting plate for cathode 24c. This is to prevent the hydrogen ions from being neutralized by the electrons flowing into from the outside.

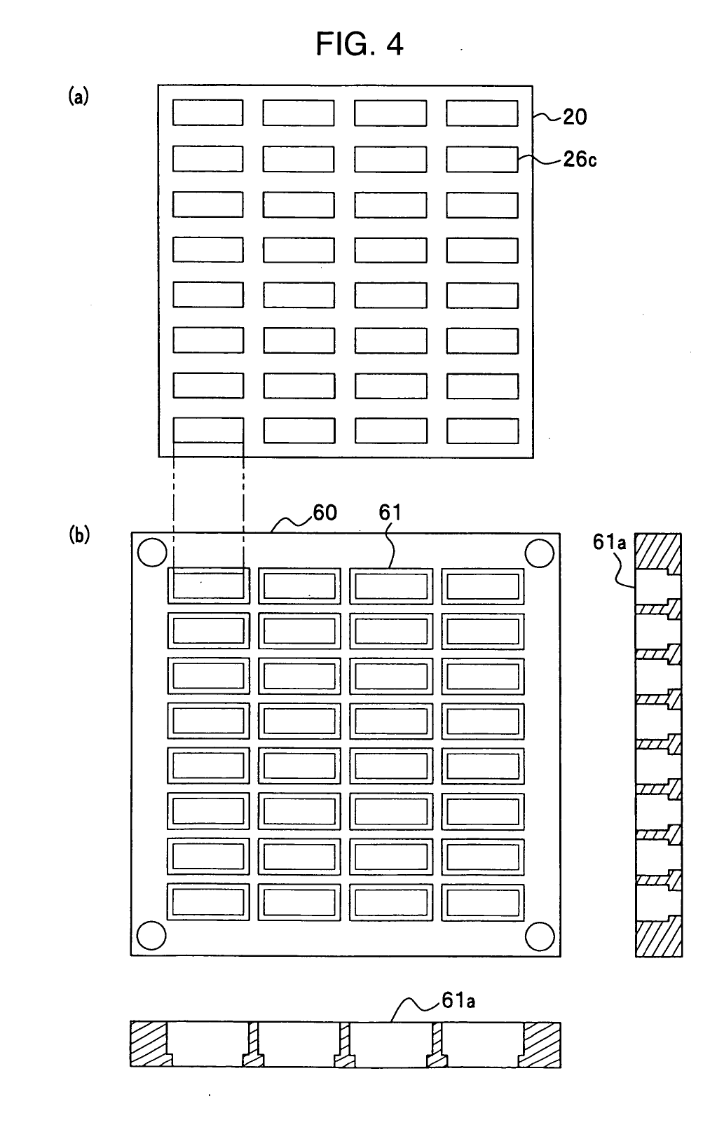

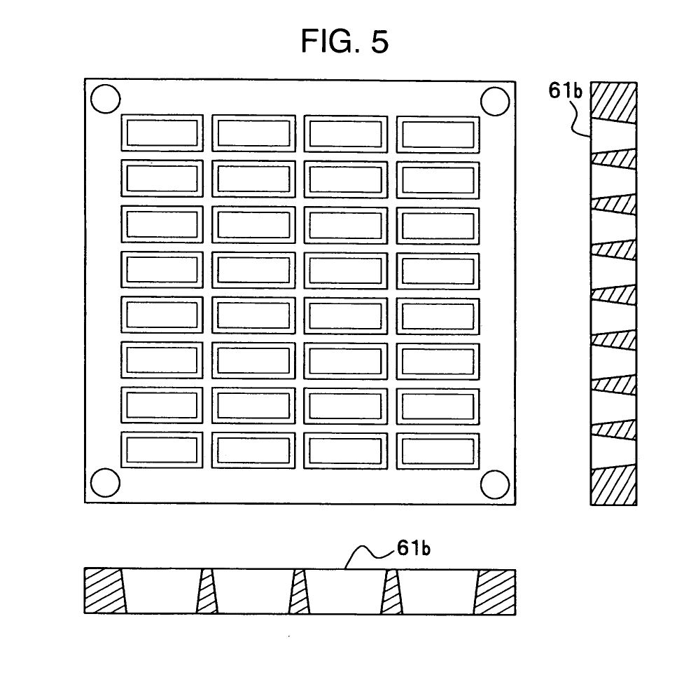

The oxygen hole 26c and supply and discharge hole 61 may have an opening of circular shape as shown in FIG. 1. However, the oxygen hole 26c provided on the membrane electrode assembly module 20 may have an opening of almost rectangular shape with a long/short side ratio of 2 or more, as shown in FIG. 4(a) presenting a horizontally cut section. Similarly, each of the supply and discharge holes 61 provided in the pressurizing member 60 in such a way to be in communication with the oxygen hole 26c, has an opening of almost rectangular shape in the horizontally cut section with a long/short side ratio of 2 or more, as shown in FIG. 4(b). Moreover, it is designed to have a vertical cut section with the outer side exposed to air having a larger opening area than the inner side on the oxygen hole 26c. More specifically, it may have a step on the inner wall (supply and discharge hole 61a, shown in FIG. 4(b) presenting a vertically cut section) or slanted inner wall (supply and discharge hole 61b shown in FIG. 5 presenting a vertically cut section). The opening of the supply and discharge hole 61 and that of the oxygen hole 26c in communication with the hole 61 are not limited to a rectangular shape shown in the figure, so long as it has a ratio of a longitudinal direction in a vertical cut section to a perpendicular direction thereof. For example, it may be elliptical.

Moreover, the supply and discharge holes 61 are surface-treated to be water-repellant by a known method to easily remove water evolving by the power-generating reaction from the holes. Removal of water, which may hinder smooth flow of oxygen, keeps stable power generating efficiency even when the fuel cell is in service for extended periods.

The fuel cell of this embodiment can control pressure on the membrane electrode assembly 21 as a power-generating element by adequately selecting the elastic member (coil spring 54a or plate spring 54b). Even when the pressurizing member 60 is bent by a clamping force by the clamping member (in other words, when pressure on the module 20 decreases in the center), it can apply a pressure to the membrane electrode assembly 21 uniformly over the entire surface by the elastic member located in the center. Thus, this embodiment provides the fuel cell 10A which can generate power at a high efficiency.

A gap-regulating member, described later, may be used also for the fuel cell of this first embodiment.

### Second Embodiment

The second embodiment of the present invention is described by referring to FIG. 6.

As shown in FIG. 6, the fuel cell 10B of this embodiment has a plurality of the membrane electrode assembly modules 20B electrically connected to each other in series or parallel, and arranged two-dimensionally on one side of the fuel chamber 30B.

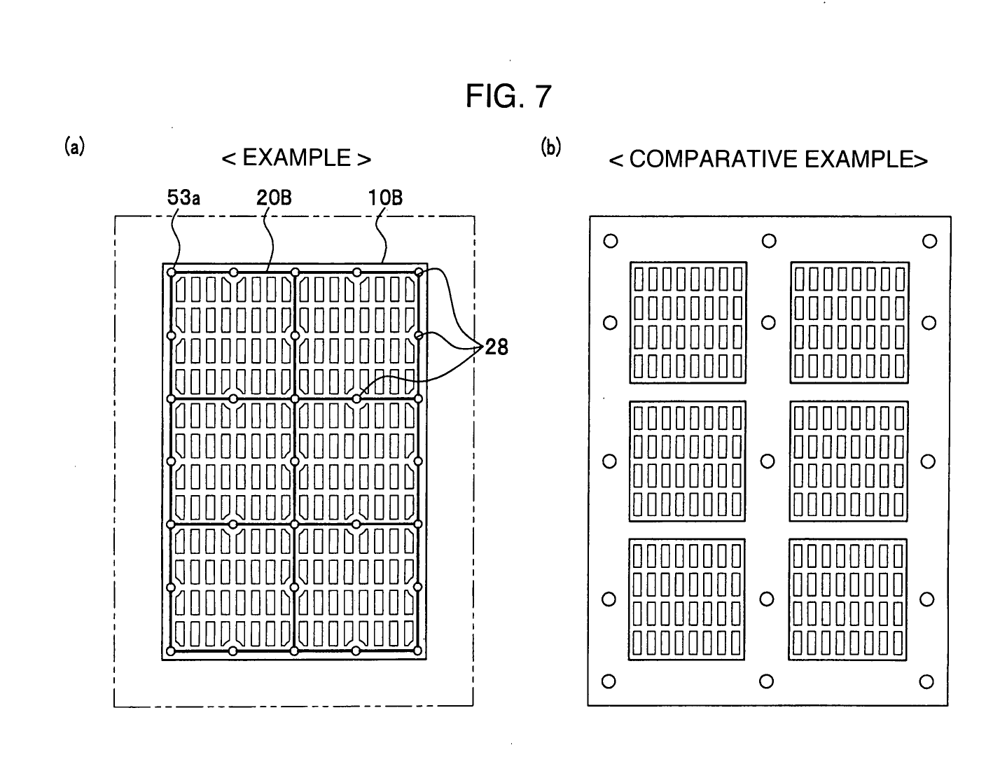

FIG. 7(a) is a plan view illustrating arrangement of the membrane electrode assembly modules 20B in this embodiment. As shown, the notches 28 are provided each in the vicinity of the hole 53a through which a bolt (clamping member 53) is inserted in the interface between the adjacent membrane electrode assembly modules 20B. As a result, these notches allow the membrane electrode assembly modules 20B to be arranged at reduced gaps. It is apparent, when compared with arrangement in a conventional structure formed in the Comparative Example shown in FIG. 7(b), that this embodiment can improve a higher mounting density of the modules on one plane of the fuel cell.

These membrane electrode assembly modules 20B shown in FIGS. 6 and 7 are electrically connected to each other in series or parallel. When they are connected in series, the collecting plate 24a for anode and collecting plate 24c for cathode are connected to each other linearly (refer to FIG. 2). The line of the modules 20B is provided with interconnections (not shown) at both ends to transmit power output to the outside.

When the modules 20 are connected in parallel, the collecting plates for anode 24a of a plurality of the membrane electrode assembly modules 20B are connected to each other, and so are the collecting plates for cathode 24c.

Returning back to FIG. 6, the description is continued.

The fuel chamber 30B in the second embodiment is composed of the cell body 34 and basal lid 32 working as the side wall and basal plane, respectively. A plurality of the membrane electrode assembly modules 20B are provided on the cell body 34 in such a way that a plurality of the fuel holes 26a (refer to FIG. 2) are exposed through the cell space 37 openings defined by the cell partitions 35. The communicating holes 36 are provided to run through the cell partitions 35 to supply the liquid fuel (methanol) to all of the cell spaces 37.

The fuel cell 10B is composed of the pressurizing member 60B, membrane electrode assembly modules 20B, cell body 34, basal lid 32 and counter member 52B which are built-up in this order, and is clamped by a plurality of bolts (clamping members 53) running through these layers.

These bolts (clamping members 53) run through the cell partitions 35, each located in the interface between a plurality of the membrane electrode assembly modules 20B. It is important to symmetrically clamp the membrane electrode assembly module 20B periphery by the clamping members 53 in order to apply a uniform pressure to the module surface. It is expected that such a uniform surface pressure reduces electrical contact resistance between the membrane electrode assembly module 20B and collecting plate 24a or 24c (refer to FIG. 2), and also improves contact between the upper side of the cell body 34 and module 20B to prevent leakage of the liquid fuel.

The plate springs (elastic members) 54b are positioned in each of the cell spaces 37, each with the basal end coming into contact with the inner basal surface of the basal lid 32 and the front end coming into contact with the membrane electrode assembly 20B to provide a uniform pressure on the entire surface. In the structure shown in FIG. 6, the pressurizing 60B will be bent when clamped by the clamping member 53 to cause a pressure distribution on the surface, as is the case with the first embodiment. However, the pressure can be uniformized and controlled by the actions of the plate springs 54b.

When the fuel cell of this embodiment is of a type of direct methanol fuel cell (DMFC), a means for discharging the by-product gas (carbon dioxide) produced in the cell spaces 37 is an essential cell component. It can be discharged to the outside by, e.g., forced circulation of the liquid fuel, or through a window of special membrane which can selectively allow the by-product gas to pas while blocking the liquid fuel, provided on the fuel chamber.

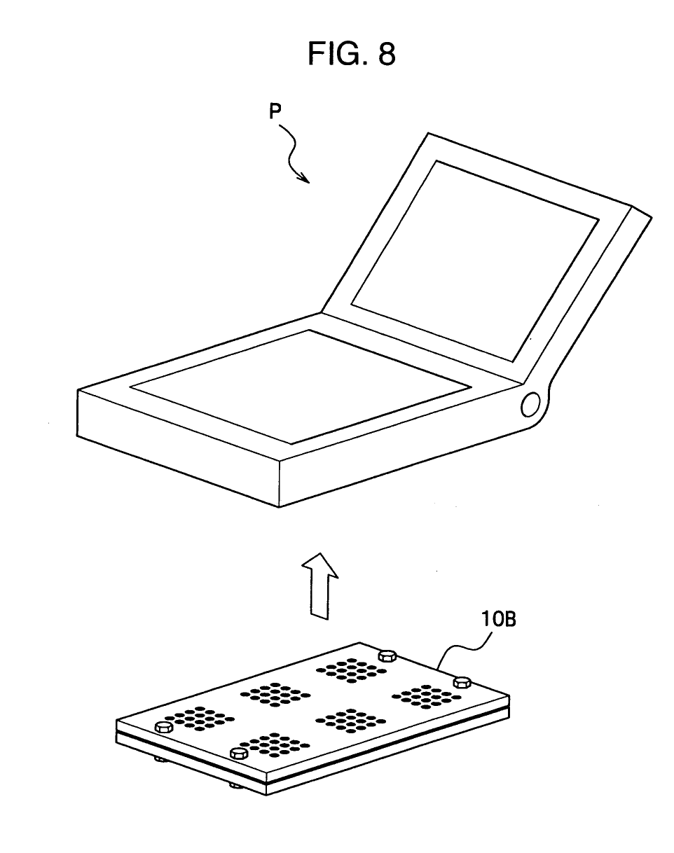

FIG. 8 shows an oblique view illustrating the portable terminal P (electronic equipment) as an electronic device of the present invention to which the fuel cell 10B having the pressurizing mechanism of the second embodiment can be attached. The membrane electrode assembly modules 20B (refer to FIG. 6) can provide a fuel cell of increased output and decreased thickness when arranged two-dimensionally without forming a gap between them. The fuel cell 10B can be an optimum power source for the portable terminal P, which is required to be light, compact and serviceable for extended periods, even when it consumes much power. The electronic device of the present invention covers a wide concept, including a portable terminal shown in FIG. 8 and other portable devices, e.g., cellular phones, PDAs and laptops, and indoor-outdoor devices, e.g., game devices.

As discussed above, the fuel cell 10B of the second embodiment comprises a plurality of the membrane electrode assembly modules 20 densely arranged without forming a gap between them, which can adequately control pressure on each of the membrane electrode assemblies 21. These densely arranged modules 20B can make the fuel cell compact as a whole with keeping a high output at a high efficiency. Therefore, the electronic device driven by the fuel cells of the present invention is serviceable for extended periods, even when it consumes much power.

### Third Embodiment

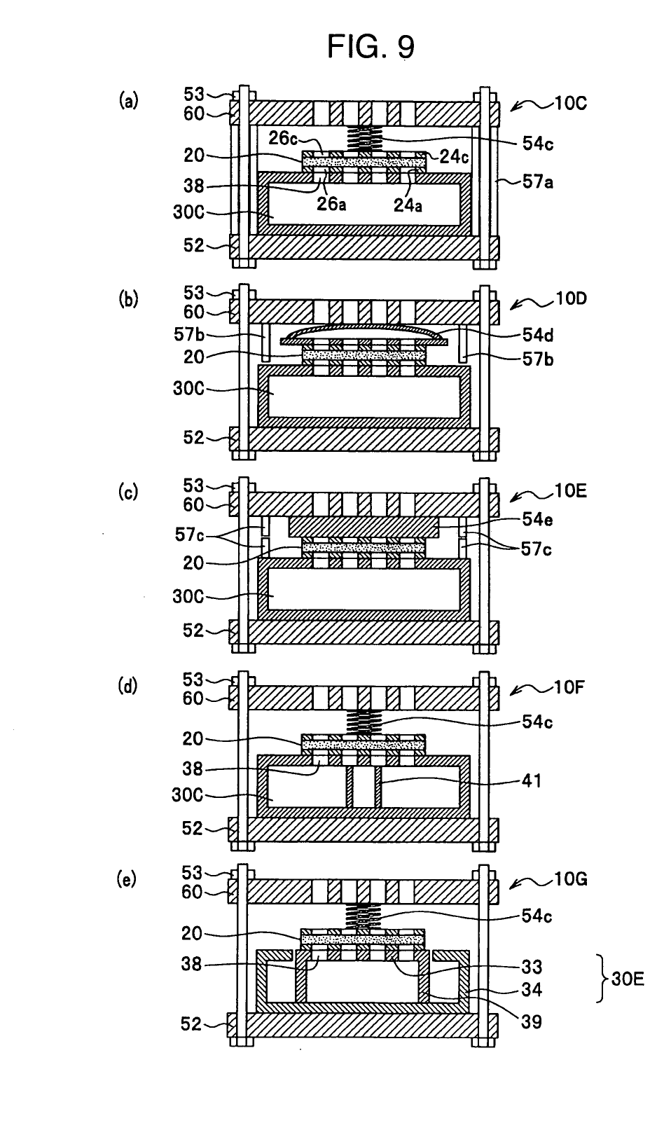

The third embodiment of the present invention is described by referring to FIG. 9.

The fuel cell 10C shown in FIG. 9(a) differs from the fuel cell 10B of the second embodiment in several ways. First, the fuel chamber is provided with a plurality of the through-holes 38 in one side, each being in communication with each of the fuel holes 26a. Second, the coil spring (elastic member) 54c has the basal end coming into contact with the pressurizing member 60 and the other end coming into contact with the collecting plate for cathode 24c, to apply a pressure to the membrane electrode assembly module 20 in the thickness direction. It is optionally provided with the gap-regulating members 57a. The component of the fuel cell 10C of the third embodiment corresponding to that of the fuel cell 10A of the first embodiment is marked with the same reference numeral, and its description is omitted to avoid unnecessary duplication.

The fuel cell 10C of the third embodiment can change extent of clamping provided by the clamping member (bolt and nut) to arbitrarily control the gap between the pressurizing member 60 and fuel chamber 30C. The coil spring (elastic member) 54c can be displaced in accordance with the changed gap to control (e.g., uniformize) pressure on the membrane electrode assembly module 20.

The gap-regulating membrane 57a comes into contact with the pressurizing member at one end and with part of the fuel chamber 30C (which includes the counter member 52 shown in the figure) at the other end to regulate the gap. The gap-regulating membrane 57a allows the fuel cell 10C to be assembled to have a given gap between the pressurizing member 60 and fuel chamber 30C without needing a special jig, thereby preventing pressure applied to the membrane electrode assembly module 20 from increasing to an excessive level.

In FIG. 9(a), the gap-regulating member 57a is structured to run through the bolt (clamping member 53), but it is not limited to this structure. For example, it may be fixed on the pressurizing member 60 or fuel chamber 30C as shown in FIG. 9(b) (the pressurizing member 60 in the figure) at one end and come into contact with the other (fuel chamber 30C in the figure) at the other end. Moreover, it may be divided into two segments, one being integrated into the pressurizing member 60 and the other into the fuel chamber 30C as shown in FIG. 9(c). These segments come into contact with each other, when clamped by the nut (clamping member 53), to regulate the gap between the pressurizing member 60 and fuel chamber 30C.

FIG. 9(b) to (e) show other conceptual types of fuel cell of the third embodiment of the present invention. In the fuel cell 10D shown in FIG. 9(b), the plate spring (elastic member) 54d arching upwards with both ends fixed is placed to come into contact with the pressurizing member 60 or collecting plate for cathode 24c (with the pressurizing member 60 in the figure) at the projection in the center. The arching direction of the plate spring 54d may be reversed, when the membrane electrode assembly module 20 is pressed insufficiently in the center.

The fuel cell 10E shown in FIG. 9(c) provides an example with the porous cushion member 54e as an elastic member, where the porous cushion member 54e totally comes into contact with the upper and lower members on both sides, with the result that it applies a pressure to the membrane electrode assembly module 20 uniformly over the entire surface.

The fuel cell 10F shown in FIG. 9(d) is further provided with the supporting column 41 in the fuel chamber 30C. It runs through the fuel chamber 30C to come into contact with the one side, working as a prop to receive a pressure from the elastic member 54c and thereby preventing a strain-caused deformation of a fuel cell 30C portion pressed by the member 54c. The supporting column 41 is effective particularly for a fuel cell with the fuel chamber 30C which is made of a flexible material to cause an insufficient pressure applied to the membrane electrode assembly module 20 in the center.

The fuel cell 10G shown in FIG. 9(e) has the fuel chamber 30E with the principal plane plate 33 and chamber body 34 to be filled with a liquid fuel, which are separated from each other. The principal plane plate 33 is served as side of the fuel chamber 30E provided with through-holes is integrated into the leg 39 corresponding to the supporting column 41 and is made of a material having a higher elastic modulus than that for the chamber body 34. This structure can reduce thickness of the fuel chamber 30E side coming into contact with the membrane electrode assembly module 20, and thereby reduce height of the whole fuel cell 10G.

Thus, the fuel cell of the third embodiment can also apply an adequate pressure to the membrane electrode assembly 21 as a power-generating element by the actions of the elastic member (coil spring 54c, plate spring 54d or cushion member 54e). Moreover, the pressure can be kept uniform even when one side of the fuel chamber 30C coming into contact with the membrane electrode assembly module 20 is bent. Still more, the fuel cell of the third embodiment can prevent an excessive pressure and an ununiform pressure when the fuel chamber 30C or 30E side is bent.

### Fourth Embodiment

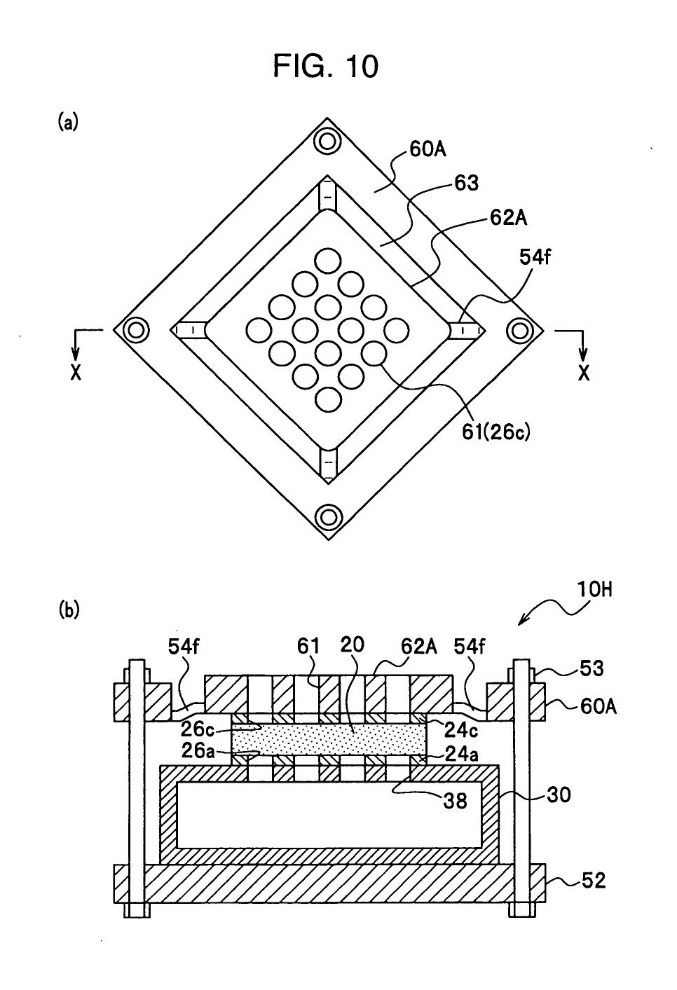

The fourth embodiment of the present invention is described by referring to FIGS. 10 to 12, where (a) is a plan view and (b) is a vertical sectional view of the cell cut along the line X-X in each figure.

Referring to FIG. 10, the fuel cell is structured to have the pressurizing plate 62A coming into contact closely with the collecting plate for cathode 24c, and a plurality of the supply and discharge holes 61 which are in communication with the corresponding oxygen holes 26c, where the pressurizing member 60A is provided with the aperture 63 through which the pressurizing plate 62A runs. Moreover, the plate springs (elastic members) 54f are fixed around the aperture 63 (at the corners near the clamping member 53 in the figure) at the basal end, and fixed around the pressurizing plate 62A (at the corners in the figure) at the front end. Thus, the pressurizing plate 62A is supported in such a way that it can be elastically displaced in the direction of the membrane electrode assembly module 20 thickness towards the pressurizing member 60A. The elastic force generated by the elastic displacement provides a pressure in the direction of the membrane electrode assembly module 20 thickness.

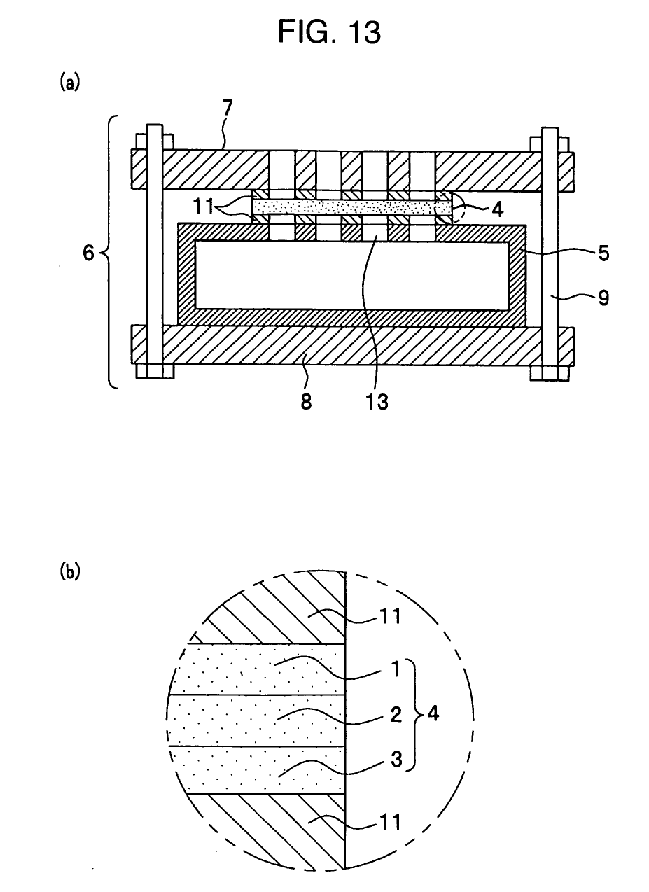

The pressure distribution is clearly found to be more uniform in the fuel cell of the fourth embodiment shown in FIG. 10 than in the one shown in FIG. 13 as confirmed by the analysis with a laser-aided strain distribution meter.

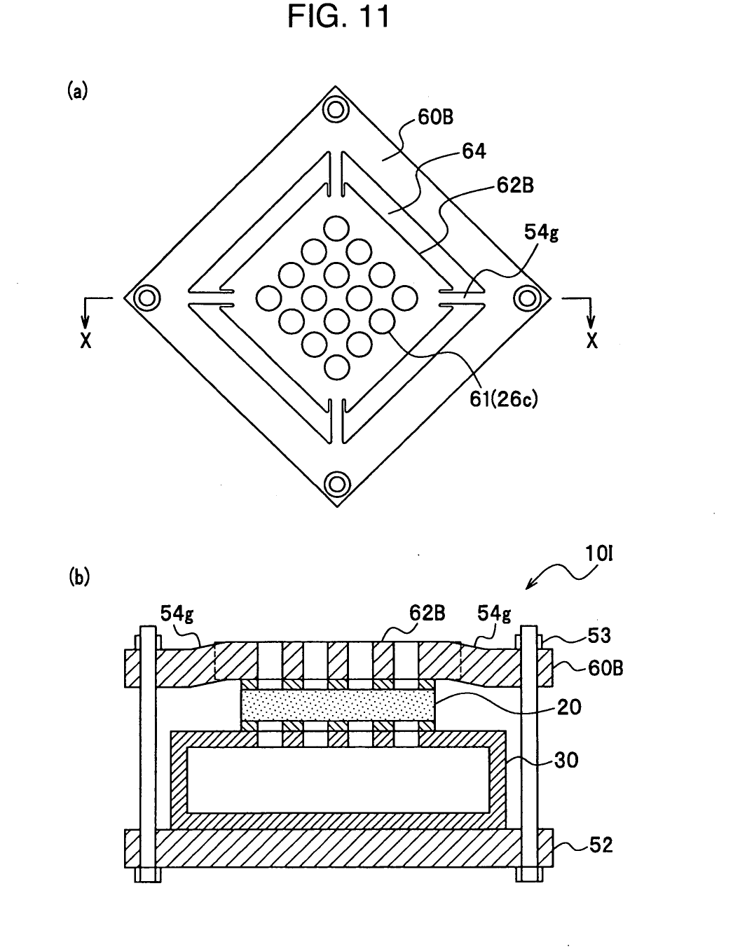

FIG. 11 shows another fuel cell type of the fourth embodiment. As shown, the pressurizing plate 62B is separated by the pressurizing member 60B by the groove 64 of a plate material hollowed out to leave the beams (elastic members) 54g. These beams 54g work as the elastic members to support the pressurizing plate 62B in such a way that it can be elastically displaced in the direction of the membrane electrode assembly module 20 thickness towards the pressurizing member 60B. This structure is also found to generate more uniform pressure than the one shown in FIG. 13.

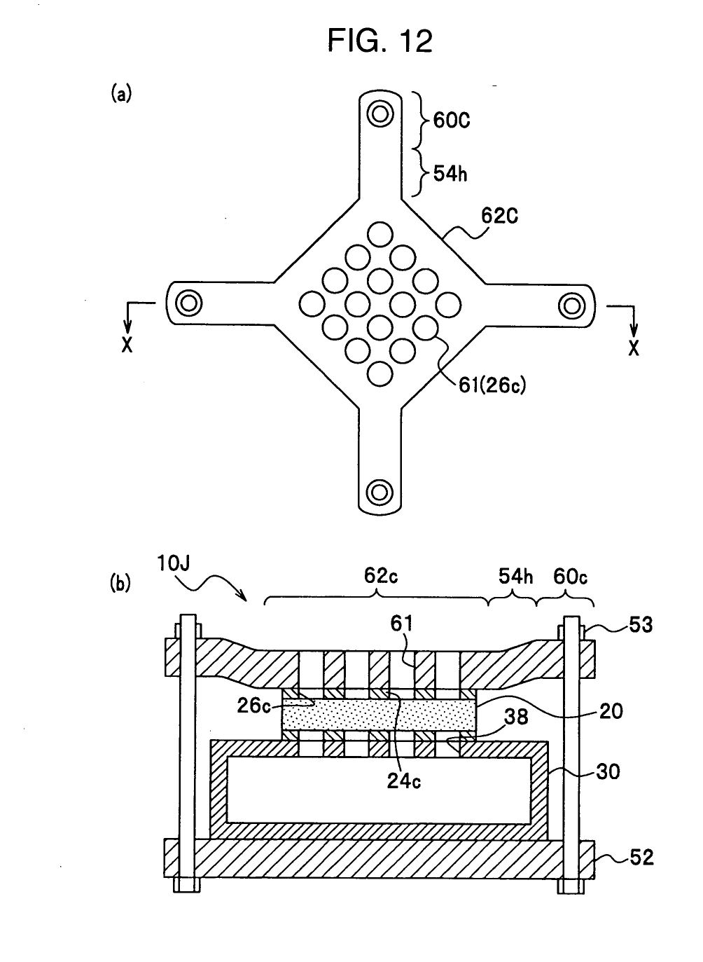

FIG. 12 shows still another fuel cell type of the fourth embodiment.

The fuel cell is structured to have the pressurizing plate 62C closely coming into contact with the collecting plate 24c for cathode, and a plurality of the supply and discharge holes 61 which are in communication with the corresponding oxygen holes 26c, where the elastic members 54h are located around the pressurizing plate 62C (at the corners in the figure), integrated thereinto at the corner in this embodiment shown in the figure, with each terminal end fixed by the bolt and nut (clamping member 53). The terminal end corresponds to the pressurizing member 60C, which, when clamped by the clamping member 53, bends the elastic member 54h to generate a pressure. This structure is also found to generate a more uniform pressure than the one shown in FIG. 13.

The gap-regulating member, described earlier, may be used also for the fuel cell of the fourth embodiment.

As discussed above, the fuel cell of the fourth embodiment can also control a pressure on the power-generating element at an adequate level. The fuel cell of the fourth embodiment, in particular, can prevent generation of uneven pressure on the membrane electrode assembly module 20 because the members coming into contact with the module 20 will not be bent when clamped by the clamping member.

The present invention is described mainly by taking fuel cells of direct methanol fuel cell (DMFC) type as the examples. However, the concept of the present invention is also applicable to other types for power generation. In particular, it is applicable to a fuel cell, whether it uses a liquid or gas as a fuel, and whether it is large or small in size, within the technical concept of the present invention.

It should be further understood by those skilled in the art that although the foregoing description has been made on embodiments of the invention, the invention is not limited thereto and various changes and modifications may be made without departing from the spirit of the invention and the scope of the appended claims.

### ADVANTAGES OF THE INVENTION

The present invention can apply an adequate pressure to the membrane electrode assembly as a power-generating element, uniformly over the entire surface.

1. A fuel cell having a mechanism for pressurizing a membrane electrode assembly comprising:
a membrane electrode assembly module comprising
a membrane electrode assembly for oxidizing a fuel on its anode and reducing oxygen on its cathode to generate power,
a collecting plate for anode, located on the anode side of the membrane electrode assembly, for transmitting the electrons generated by the oxidation and
a collecting plate for cathode, located on the cathode side of the membrane electrode assembly, for supplying the electrons needed for the reduction, and
a fuel chamber, located on the anode side of the membrane electrode assembly module, for supplying the fuel which it holds in its inner space to the membrane electrode assembly, wherein the fuel cell is further provided with:
an elastic member in the fuel chamber to come into contact with the collecting plate for anode for applying a pressure to the membrane electrode assembly and
a pressurizing member for pressing, in cooperation with a clamping member, the membrane electrode assembly module towards the fuel chamber.

2. A fuel cell having a mechanism for pressurizing a membrane electrode assembly comprising:
a membrane electrode assembly module comprising
a membrane electrode assembly for oxidizing a fuel on its anode and reducing oxygen on its cathode to generate power,
a collecting plate for anode, located on the anode side of the membrane electrode assembly, for transmitting the electrons generated by the oxidation and
a collecting plate for cathode, located on the cathode side of the membrane electrode assembly, for supplying the electrons needed for the reduction, and
a fuel chamber, located on the anode side of the membrane electrode assembly module, for supplying the fuel which it holds in its inner space to the membrane electrode assembly, wherein the fuel cell is further provided with:
an elastic member coming into contact with the collecting plate for cathode for applying a pressure to the membrane electrode assembly, and
a pressurizing member fixed on the fuel chamber by a clamping member receiving a repulsive force to the pressure provided by the elastic member.

3. The fuel cell having a mechanism for pressurizing a membrane electrode assembly according to claim 1 or 2, wherein the elastic member is a coil spring.

4. The fuel cell having a mechanism for pressurizing a membrane electrode assembly according to claim 1 or 2, wherein the elastic member is a plate spring.

5. The fuel cell having a mechanism for pressurizing a membrane electrode assembly according to claim 1 or 2, wherein the elastic member is a porous cushion member.

6. A fuel cell having a mechanism for pressurizing a membrane electrode assembly comprising:
a membrane electrode assembly module comprising
a membrane electrode assembly for oxidizing a fuel on its anode and reducing oxygen on its cathode to generate power,
a collecting plate for anode, located on the anode side of the membrane electrode assembly, for transmitting the electrons generated by the oxidation and
a collecting plate for cathode, located on the cathode side of the membrane electrode assembly, for supplying the electrons needed for the reduction, and
a fuel chamber, located on the anode side of the membrane electrode assembly module, for supplying the fuel which it holds in its inner space to the membrane electrode assembly, wherein the fuel cell is further provided with:
a pressurizing plate coming into contact closely with the collecting plate for cathode,
an elastic member with one end fixed around the pressurizing plate for applying a pressure on the membrane electrode assembly in the thickness direction, and
a pressurizing member fixed on the other end of the elastic member and the fuel chamber by a clamping member.

7. The fuel cell having a mechanism for pressurizing a membrane electrode assembly according to one of claims 1, 2 and 6, wherein a gap-regulating member is provided with one end coming into contact with the pressurizing member and the other end coming into contact with the part of the fuel chamber to regulate the gap between them.

8. The fuel cell having a mechanism for pressurizing a membrane electrode assembly according to claim 7, wherein the gap-regulating member is divided with one segment integrated into the pressurizing member and the other segment into the fuel chamber, respectively, at the portion coming into contact with the member or chamber.

9. The fuel cell having a mechanism for pressurizing a membrane electrode assembly according to claim 2, wherein a supporting column is provided in the inner space of the fuel chamber to receive the pressure provided by the elastic member.

10. The fuel cell having a mechanism for pressurizing a membrane electrode assembly according to claim 9, wherein the fuel chamber is composed of separated segments, the one which comes into contact with the membrane electrode assembly module being made of a material having a higher elastic modulus than the other and is integrated into the supporting column.

11. The fuel cell having a mechanism for pressurizing a membrane electrode assembly according to claim 1, wherein the pressurizing member is provided with supply and discharge holes through which oxygen is supplied and water evolved by the reduction is discharged, each hole being surface-treated to be water-repellent.

12. The fuel cell having a mechanism for pressurizing a membrane electrode assembly according to claim 6, wherein the pressurizing member is provided with supply and discharge holes through which oxygen is supplied and water evolving by the reduction is discharged, each hole being surface-treated to be water-repellent.

13. The fuel cell having a mechanism for pressurizing a membrane electrode assembly according to claim 11 or 12, wherein the supply and discharge hole has a ratio of a longitudinal direction in a vertical cut section to a perpendicular direction thereof which is 2 or more.

14. The fuel cell having a mechanism for pressurizing a membrane electrode assembly according to claim 11 or 12, wherein the supply and discharge hole has a structure with the outer side exposed to air having a larger opening area than the inner side coming into contact with the membrane electrode assembly module.

15. The fuel cell having a mechanism for pressurizing a membrane electrode assembly according to one of claims 1, 2 and 6, wherein
a plurality of the membrane electrode assembly modules are electrically connected to each other in series or parallel, and arranged two-dimensionally on one side of the fuel chamber, and
each of the modules is provided with notches, each in the vicinity of the clamping member to be inserted in the interface between the adjacent modules.

16. An electronic device equipped with the fuel cell having a mechanism for pressurizing a membrane electrode assembly according to one of claims 1, 2 and 6.
